(19) United States
(12) Patent Application Publication
(10) Pub. No.: US 2013/0307496 A1
(43) Pub. Date: Nov. 21, 2013

(54) SEMICONDUCTOR DEVICE AND DRIVING METHOD THEREOF

(71) Applicant: Semiconductor Energy Laboratory Co., Ltd., Atsugi-shi (JP)

(72) Inventor: Kazunori Watanabe, Atsugi (JP)

(73) Assignee: Semiconductor Energy Laboratory Co., Ltd., Atsugi-shi (JP)

(21) Appl. No.: 13/893,396

(22) Filed: May 14, 2013

(30) Foreign Application Priority Data
May 18, 2012 (JP) 2012-114473

(51) Int. Cl. H02M 3/07

(52) U.S. Cl. CPC H02M 3/07
USPC 323/234

(57) ABSTRACT

One object of the invention is to reduce discharge of electric charge from a capacitor when supply of power supply voltage to a charge pump circuit is stopped and restarted, so that a time required after the supply of power supply voltage is restarted and before an input signal is boosted is shortened. A semiconductor device includes a boosting circuit portion including a charge transfer element and a capacitor, boosting a voltage level of an input signal, and outputting an output signal having a boosted voltage level; a detection circuit monitoring a voltage level of the output signal; and a control circuit outputting a signal for controlling boosting of the voltage level of the input signal to the boosting circuit portion in accordance with the voltage level obtained by the detection circuit. The boosting circuit portion includes a switch electrically connected to the capacitor and the charge transfer element.

### BACKGROUND OF THE INVENTION

1. Field of the Invention

The present invention relates to a semiconductor device which functions as a charge pump circuit and a method for driving the semiconductor device. In particular, the present invention relates to a semiconductor device capable of holding electric charge accumulated in a capacitor included in a charge pump circuit even after power is turned off, and a method for driving the semiconductor device.

Note that in this specification, a semiconductor device refers to a device including a semiconductor element. Thus, a charge pump circuit which is to be described in this specification is a semiconductor device.

2. Description of the Related Art

A charge pump circuit in which a plurality of charge transfer elements and capacitors are used is known as a circuit which boosts a signal of a constant voltage input to the charge pump circuit and outputs a signal having the boosted voltage level. Examples of the charge transfer element include a diode and a transistor.

A basic circuit configuration of a charge pump circuit is disclosed in Patent Document 1 described below.

### REFERENCE

### Patent Document

[Patent Document 1] Japanese Published Patent Application No. 2000-270541

### SUMMARY OF THE INVENTION

A charge pump circuit operates so as to boost an input signal to be output when supply of power supply voltage is performed. The charge pump circuit stops operation of the circuit when supply of power supply voltage is stopped. Here, the operation of the circuit means a transfer of electric charge or a boost of an input signal with the use of a clock signal or a control signal.

When the supply of power supply voltage is stopped, in the charge pump circuit, electric charge accumulated in a capacitor is discharged in each case in order to boost an input signal. In the charge pump circuit, the discharged electric charge needs to be newly accumulated in the capacitor when the supply of power supply voltage is restarted, which leads to a problem that it takes a long time to boost an input signal to be output.

In view of the above problem, an object of one embodiment of the present invention is to reduce discharge of electric charge from a capacitor when supply of power supply voltage to a charge pump circuit is stopped and restarted so that a time required after the supply of power supply voltage is restarted and before an input signal is boosted can be shortened.

One embodiment of the present invention is a semiconductor device including a boosting circuit portion which includes a charge transfer element and a capacitor and which boosts a voltage level of an input signal and outputs an output signal having the boosted voltage level; a detection circuit which monitors a voltage level of the output signal; and a control circuit which outputs a signal for controlling boosting of the voltage level of the input signal to the boosting circuit portion in accordance with the voltage level obtained by the detection circuit. In the semiconductor device, the boosting circuit portion includes a switch electrically connected to the capacitor and the charge transfer element.

One embodiment of the present invention is a semiconductor device including a boosting circuit portion which includes a charge transfer element and a capacitor and which boosts a voltage level of an input signal and outputs an output signal having the boosted voltage level; a detection circuit which monitors a voltage level of the output signal; and a control circuit which outputs a signal for controlling boosting of the voltage level of the input signal to the boosting circuit portion in accordance with the voltage level obtained by the detection circuit. In the semiconductor device, the boosting circuit portion includes a switch electrically connected to the capacitor and the charge transfer element, and the switch is a transistor in which an off-state current per channel width is lower than or equal to 1×10⁻²² A/μm.

In the semiconductor device according to one embodiment of the present invention, a semiconductor layer of the transistor is preferably an oxide semiconductor.

In the semiconductor device according to one embodiment of the present invention, the charge transfer element is preferably a diode element.

One embodiment of the present invention is a method for driving a semiconductor device including the steps of turning off a switch electrically connected to a capacitor and a charge transfer element in a boosting circuit portion in a period in which supply of power supply voltage is stopped and turning on the switch in a period in which supply of power supply voltage is performed.

In the method for driving a semiconductor device according to one embodiment of the present invention, the switch is preferably a transistor in which an off-state current per channel width is lower than or equal to 1×10⁻²² A/μm.

In the method for driving a semiconductor device according to one embodiment of the present invention, a semiconductor layer of the transistor is preferably an oxide semiconductor.

According to the one embodiment of the present invention, discharge of electric charge from a capacitor can be reduced when supply of power supply voltage to a charge pump circuit is stopped and restarted, so that a time required after the supply of power supply voltage is restarted and before an input signal is boosted can be shortened.

### BRIEF DESCRIPTION OF THE DRAWINGS

In the accompanying drawings:

FIG. 1 is a circuit diagram of a charge pump circuit;

FIG. 2 is a circuit diagram of a charge pump circuit;

FIG. 3 is Arrhenius plots for illustrating off-state current;

FIG. 4 is a circuit diagram of a control circuit;

FIG. 5 is a timing chart of the charge pump circuit;

FIG. 6 is a circuit diagram of a charge pump circuit;

FIGS. 7A and 7B are a circuit diagram of a charge pump circuit and a timing chart thereof;

FIG. 8 is a circuit diagram of a charge pump circuit; and

FIG. 9 is a cross-sectional view of transistors included in a semiconductor device.

### DETAILED DESCRIPTION OF THE INVENTION

Hereinafter, embodiments of the present invention will be described with reference to the accompanying drawings. However, the present invention can be carried out in many different modes, and those skilled in the art could appreciate that a variety of modifications can be made to the embodiment and details of the present invention without departing from the spirit and scope of the present invention. Thus, the present invention should not be interpreted as being limited to the description of the embodiments. Note that identical portions or portions having the same function in all drawings illustrating the structure of the invention that are described below are denoted by the same reference numeral.

Note that, the size, layer thickness, and signal waveform of each object shown in the drawings and the like in the embodiments are exaggerated for simplicity in some cases. Therefore, embodiments of the present invention are not limited to such scales.

Functions of a “source” and a “drain” of a transistor are sometimes replaced with each other when a transistor of opposite polarity is used or when the direction of current flowing is changed in circuit operation, for example. Therefore, the terms “source” and “drain” can be used to denote the drain and the source, respectively, in this specification.

In addition, in this specification and the like, the term such as “electrode” or “wiring” does not limit a function of a component. For example, an “electrode” is sometimes used as part of a “wiring”, and vice versa. Furthermore, the term “electrode” or “wiring” can include the case where a plurality of “electrodes” or “wirings” is formed in an integrated manner.

### Embodiment 1

In this embodiment, a circuit configuration of a charge pump circuit that is a semiconductor device, and a method for driving the charge pump circuit are described.

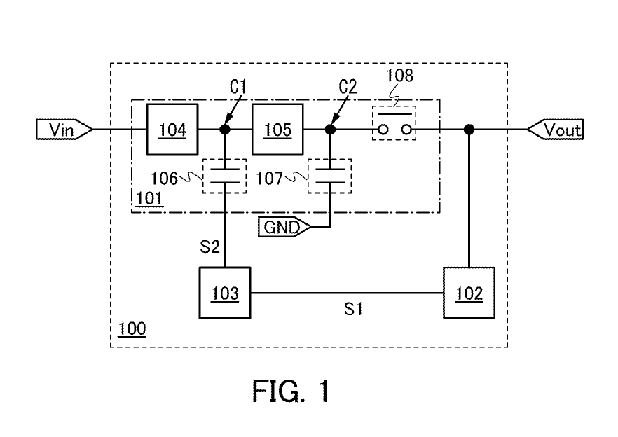

A charge pump circuit 100 shown in FIG. 1 includes a boosting circuit portion 101, a detection circuit 102, and a control circuit 103. The boosting circuit portion 101 includes a charge transfer element 104, a charge transfer element 105, a capacitor 106, a capacitor 107, and a switch 108.

In the boosting circuit portion 101, a voltage level of an input signal Vin is boosted and an output signal Vout having the boosted voltage level is output. Specifically, electric charge input from the input signal Vin is held in a node C1 connected to one electrode of the capacitor 106, and a voltage level of the other electrode of the capacitor 106 is increased when the node C1 is brought into an electrically floating state, whereby a voltage level of the node C1 is further increased from the voltage level of the input signal Vin to be boosted. The electric charge is transferred to a node C2 due to the increase and decrease in the voltage level of the node C1, so that a voltage level of the node C2 can be increased.

Note that in one embodiment of the present invention described in this embodiment, as a structure of the boosting circuit portion 101, an example in which the voltage level of the input signal Vin is boosted and an output signal Vout having the boosted voltage level is output is illustrated; however, one embodiment of the present invention includes the case where the voltage level of the input signal Vin is decreased to output the output signal Vout.

The charge transfer element 104 is an element in which a charge transfer from a node to which an input signal Vin is input to the node C1 is performed, for example. The charge transfer element 105 is an element in which a charge transfer from the node C1 to the node C2 is performed. As each of the charge transfer element 104 and the charge transfer element 105, a diode element or a transistor may be used. Electric charge transferred by the charge transfer element 104 and the charge transfer element 105 may be positive electric charge or negative electric charge, and the charge transfer element 104 and the charge transfer element 105 each may be an element capable of increasing or decreasing a voltage level by the transfer of electric charge in the boosting circuit portion 101.

Further, when the switch 108 is turned on, the node C2 connected to one electrode of the capacitor 107 is electrically connected to a node from which the output signal Vout is output. The node C2 is brought into an electrically floating state when the switch 108 is turned off, and electric charge is held in the capacitor 107. The other electrode of the capacitor 107 is supplied with a signal with a certain voltage level, and is connected to a ground line GND in an example shown in FIG. 1.

In FIG. 1, two pairs of the charge transfer elements and the capacitors included in the boosting circuit portion 101 are illustrated; however, a voltage level to be boosted can be increased by provision of the charge transfer elements and the capacitors which are connected in multiple stages including three or more stages.

The switch 108 controls electrical connection between the node C2 and the node from which the output signal Vout is output. Specifically, the switch 108 is turned on when power supply voltage is supplied to the charge pump circuit 100, and the switch 108 is turned off when supply of power supply voltage to the charge pump circuit 100 is stopped. By turning on the switch 108, the charge pump circuit 100 can output the output signal Vout having a boosted voltage level by boosting a voltage level of the input signal Vin. In addition, by turning off the switch 108, the charge pump circuit 100 can reduce discharge of electric charge from the capacitor 106 and the capacitor 107 even when the supply of power supply voltage is stopped, and a time required after the supply of power supply voltage is restarted and before the input signal Vin is boosted can be shortened.

The detection circuit 102 is a circuit which monitors a voltage level of the output signal Vout. Specifically, the detection circuit 102 is a circuit which connects resistors to the node from which the output signal Vout is output and outputs a voltage level as a signal S1, which is obtained by resistance division using the resistors, to the control circuit 103.

The control circuit 103 is a circuit which outputs a signal S2 to the other electrode of the capacitor 106 in accordance with the signal S1 output from the detection circuit 102. The signal S2 is a signal obtained by intermittently outputting a clock signal in accordance with the signal S1.

Note that in the case where the charge transfer elements and the capacitors included in the boosting circuit portion 101 are formed in multiple stages including three or more stages, the signal S2 is used with an inverted signal of the signal S2. In that case, for example, the signal S2 is output to the other electrodes of the capacitors in the odd stages, and the inverted signal of the signal S2 is output to the other electrodes of the capacitors in the even stages.

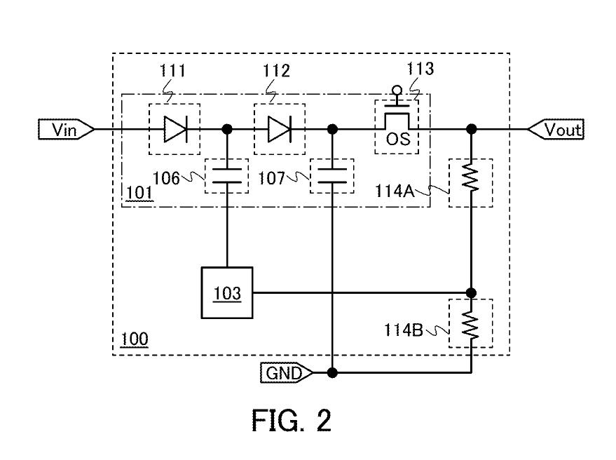

FIG. 2 shows a circuit diagram of the charge pump circuit 100 that shows a specific circuit configuration of the boosting circuit portion 101 and the detection circuit 102 which are shown in FIG. 1.

The boosting circuit portion 101 shown in FIG. 2 includes a diode element 111, a diode element 112, the capacitor 106, the capacitor 107, and a transistor 113.

With the use of the diode element 111 as the charge transfer element 104 shown in FIG. 1, positive electric charge can be transferred from the node to which the input signal Vin is input to the node C1 when the voltage level of the node to which the input signal Vin is input is higher than that of the node C1, and the node C1 can be brought into an electrically floating state when the voltage level of the node to which the input signal Vin is input is lower than that of the node C1. Further, with the use of the diode element 112 as the charge transfer element 105 shown in FIG. 1, electric charge can be transferred from the node C1 to the node C2 when the voltage level of the node C2 is lower than that of the node C1, and the node C1 can be brought into an electrically floating state when the voltage level of the node C2 is higher than that of the node C1.

Any one of a coil element, a resistor, and a capacitor, or a combination thereof may be provided between the charge transfer elements.

Other than the use of a diode element as shown in FIG. 2 as the charge transfer element, switching of a transistor enables electric charge between the node C1 and the node to which the input signal Vin is input to be transferred and the electric charge between the node C1 and the node C2 to be transferred.

Electric charge can be held in the node C2 surround by the diode element 112, the capacitor 107, and the transistor 113 when the transistor 113 which can be used as the switch has an off-state current per channel width of the transistor of lower than or equal to 1×10⁻²² A/μm or less, that is extremely smaller than an off-state current of a transistor including a semiconductor layer containing silicon.

In this embodiment, for a structure in which an off-state current per channel width of the transistor is extremely reduced to 1×10⁻²² A/μm or less, it is preferable to use a transistor whose channel is formed in an oxide semiconductor layer. Note that the transistor 113 is marked with OS in the figure so that it is recognized as being a transistor whose channel is formed in an oxide semiconductor layer.

A material which can realize off-state current characteristics equivalent to those of the oxide semiconductor material may be used instead of the oxide semiconductor material. For example, a wide gap material like silicon carbide (more specifically, a semiconductor material whose energy gap Eg is larger than 3 eV) can be used. A MEMS switch, or the like may be used instead of a transistor to break connection between wirings, whereby electric charge can be held.

Note that a transistor included in the control circuit 103 can include a semiconductor layer different from that of the transistor 113. For example, a transistor included in the control circuit 103 may be a transistor whose channel is formed in a silicon layer or a silicon substrate.

Here, an oxide semiconductor used for the semiconductor layer of the transistor 113 is described in detail.

At least indium (In) or zinc (Zn) is preferably contained in an oxide semiconductor used for the semiconductor layer of the transistor. In particular, In and Zn are preferably contained. A stabilizer for strongly bonding oxygen is preferably contained in addition to In and Zn. As a stabilizer, at least one of gallium (Ga), tin (Sn), zirconium (Zr), hafnium (Hf), and aluminum (Al) may be contained.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) may be contained.

As the oxide semiconductor, the following can be used, for example: an In—Sn—Ga—Zn-based oxide, an In—Ga—Zn-based oxide, an In—Sn—Zn-based oxide, an In—Zr—Zn-based oxide, an In—Al—Zn-based oxide, a Sn—Ga—Zn-based oxide, an Al—Ga—Zn-based oxide, a Sn—Al—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Zn-based oxide, a Sn—Zn-based oxide, an Al—Zn-based oxide, a Zn—Mg-based oxide, a Sn—Mg-based oxide, an In—Mg-based oxide, or an In—Ga-based oxide, an In-based oxide, a Sn-based oxide, or a Zn-based oxide.

Note that here, for example, an In—Ga—Zn-based oxide refers to an oxide mainly containing In, Ga, and Zn, and there is no limitation on the ratio of In to Ga and Zn.

Alternatively, a material represented by In/MO₃(ZnO)ₘ (m>0 is satisfied) may be used as an oxide semiconductor. Note that M represents one or more metal elements selected from Ga, Fe, Mn, and Co. Still alternatively, a material represented by In₂SnO₅(ZnO)ₙ (n>0 is satisfied) may be used as an oxide semiconductor.

For example, an In—Ga—Zn-based oxide with an atomic ratio of In:Ga:Zn=3:1:2, 1:1:1, or 2:2:1, or an oxide whose atomic ratio is in the neighborhood of the above atomic ratios can be used. Alternatively, an In—Sn—Zn-based oxide with an atomic ratio of In:Sn:Zn=1:1:1, In:Sn:Zn=2:1:3, or In:Sn:Zn=2:1:5, or an oxide with an atomic ratio close to the above atomic ratios may be used.

Note that for example, the expression “the composition of an oxide including In, Ga, and Zn at the atomic ratio, In:Ga:Zn=a:b:c (a+b+c=1), is in the neighborhood of the composition of an oxide including In, Ga, and Zn at the atomic ratio, In:Ga:Zn=A:B:C (A+B+C=1)” means that a, b, and c satisfy the following relation (1).

(a-A)²+(b-B)²+(c-C)²≦r² (1)

For example, r may be 0.05. The same applies to other oxides.

However, the composition of the oxide semiconductor is not limited to those described above, and an oxide semiconductor having an appropriate composition may be used depending on necessary semiconductor characteristics (e.g., field-effect mobility or threshold voltage). In order to obtain the required semiconductor characteristics, it is preferable that the carrier concentration, the impurity concentration, the defect density, the atomic ratio between a metal element and oxygen, the interatomic distance, the density, and the like be set to appropriate values.

When an oxide semiconductor is highly purified, the off-state current of a transistor using an oxide semiconductor for a semiconductor layer can be sufficiently reduced (here, the off-state current means a drain current when a potential difference between a source and a gate is equal to or lower than the threshold voltage in the off state, for example). A highly purified oxide semiconductor can be obtained, for example, in such a manner that a film is deposited while heating is performed so as to prevent hydrogen and a hydroxyl group from being contained in the oxide semiconductor, or heat treatment is performed after film deposition so as to remove hydrogen and a hydroxyl group from the film.

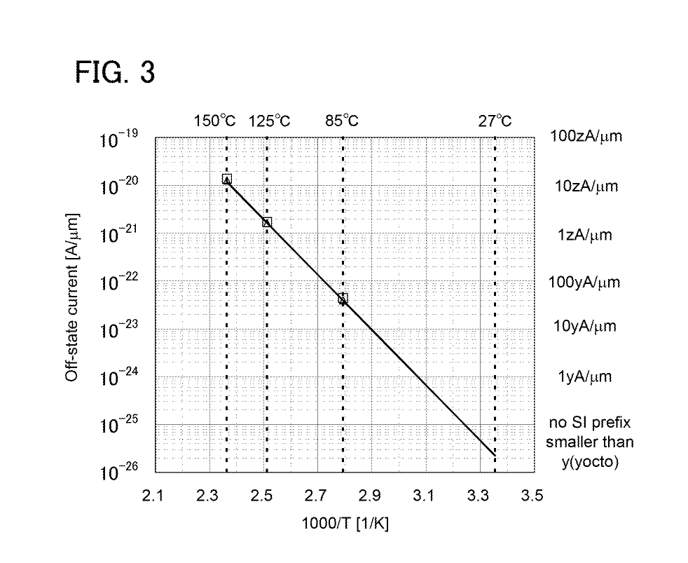

In order to detect extremely low off-state current due to the use of a highly purified oxide semiconductor, a relatively large transistor is fabricated to measure the off-state current, whereby an off-state current that actually flows can be estimated. FIG. 3 shows Arrhenius plots of the off-state current per channel width W of 1 μm of a large transistor having a channel width W of 1 m (1000000 μm) and a channel length L of 3 μm when the temperature changes to 150° C., 125° C., 85° C., and 27° C. As seen from FIG. 3, it is found that the off-state current is as extremely small as 3×10⁻²⁶ A/μm at 27° C. The reason that the off-state current is measured at elevated temperature is that the off-state current cannot be measured at room temperature because it is a very low current.

In the case where a highly purified In—Ga—Zn-based-oxide semiconductor is used for a channel region of a transistor having a channel length of 10 μm, a semiconductor film thickness of 30 nm, and a drain voltage of about 1 V to 10 V, the off-state current of the transistor can be reduced to ×10⁻¹³ A or less. In addition, the off-state current per channel width (the value obtained by dividing the off-state current by the channel width of the transistor) can be made about 1×10⁻²³ A/μm (10 yA/μm) to 1×10⁻²² A/μm (100 yA/μm).

The above is the description of the oxide semiconductor used for the semiconductor layer of the transistor 113.

The transistor 113 having an off-state current per channel width of 1×10⁻²² A/μm or less, which is extremely smaller than the off-state current of a transistor including a semiconductor layer containing silicon can output the output signal Vout in accordance with electric charge of the node C2 to an external circuit when the transistor 113 is on. Further, by turning off the transistor 113, the electric charge of the node C1 and the node C2 can be held even when supply of power supply voltage to the charge pump circuit 100 is stopped.

A resistor 114A and a resistor 114B included in the detection circuit are connected to the node from which the output signal Vout is output, so that the signal S1 can be generated in accordance with the voltage level of the output signal Vout and can be output to the control circuit 103.

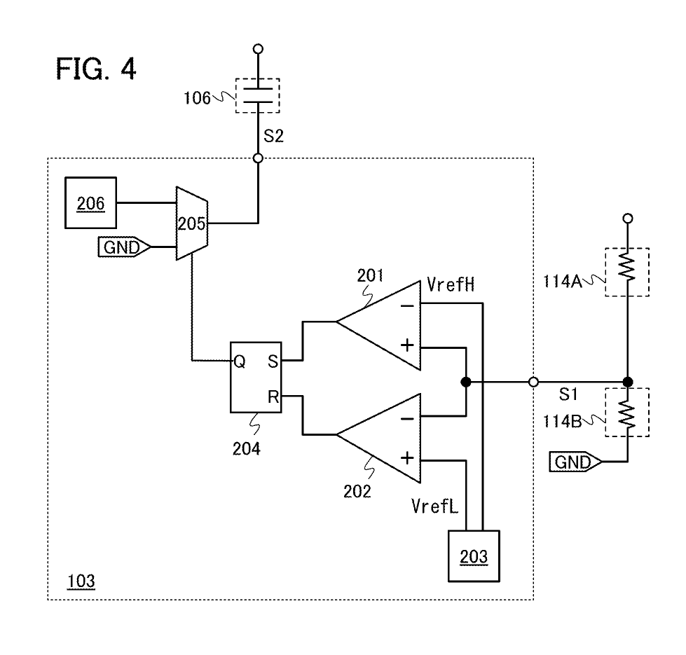

FIG. 4 is an example of a specific circuit of the control circuit 103 shown in FIG. 1 and FIG. 2.

The control circuit 103 in FIG. 4 includes an operation amplifier 201, an operation amplifier 202, a reference voltage generation circuit 203, a flip-flop circuit 204, a selector circuit 205, and an oscillator circuit 206.

The signal S1 output from the detection circuit 102 is input to a non-inverting input terminal of the operation amplifier 201 and an inverting input terminal of the operation amplifier 202. Further, a voltage level VrefH is input to an inverting input terminal of the operation amplifier 201 from the reference voltage generation circuit 203. Furthermore, a voltage level VrefL is input to a non-inverting input terminal of the operation amplifier 202 from the reference voltage generation circuit 203. Note that the voltage level VrefH is higher than the voltage level VrefL.

The flip-flop circuit 204 is a set-reset type flip-flop circuit. An output signal of the operation amplifier 201 is input to a set terminal (S). An output signal of the operation amplifier 202 is input to a reset terminal (R). An output signal is output to an output terminal (Q).

The selector circuit 205 is configured to switch a clock signal output from the oscillator circuit 206 and a ground potential of a ground line GND in accordance with an output signal of the flip-flop circuit 204 and output either of them as the signal S2.

The signal S2 is output to the other electrode of the capacitor 106 included in the boosting circuit portion 101 in FIG. 1 and FIG. 2 as described above.

With the above-described circuit configuration in FIG. 4, the control circuit 103 can operate in such a manner that the selector circuit 205 switches to a clock signal to be output as the signal S2 when the voltage level of the signal S1 is lower than or equal to the VrefL or to the ground potential to be output as the signal S2 when the voltage level of the signal S1 is higher than or equal to VrefH. In other words, the control circuit 103 outputs a signal for boosting voltage in the boosting circuit portion 101 as the signal S2 when the voltage level of the signal S1 is lower than or equal to VrefL, or outputs a signal for stopping the boosting in the boosting circuit portion 101 as the signal S2 when the voltage level of the signal Si is higher than or equal to VrefH.

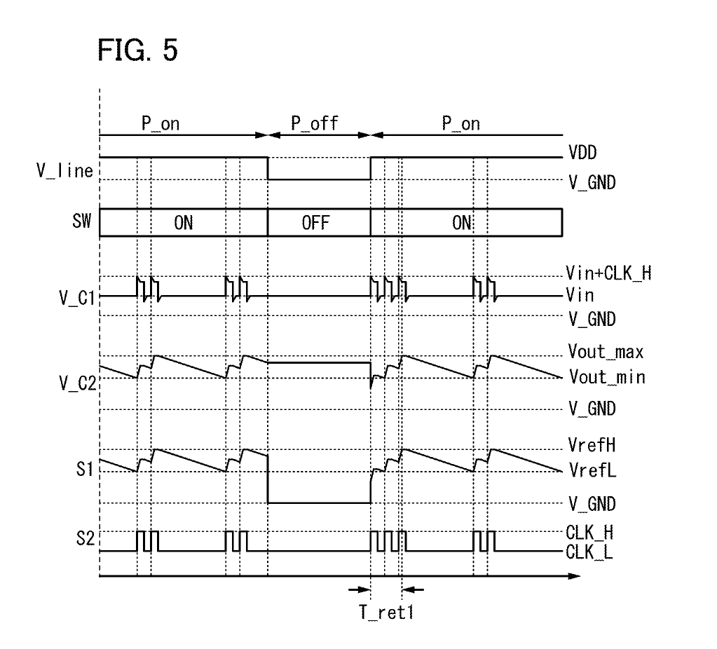

Next, normal operation of the charge pump circuit 100 shown in FIG. 1 and operation thereof at the time when supply of power supply voltage is stopped and restarted are described with reference to the timing chart in FIG. 5.

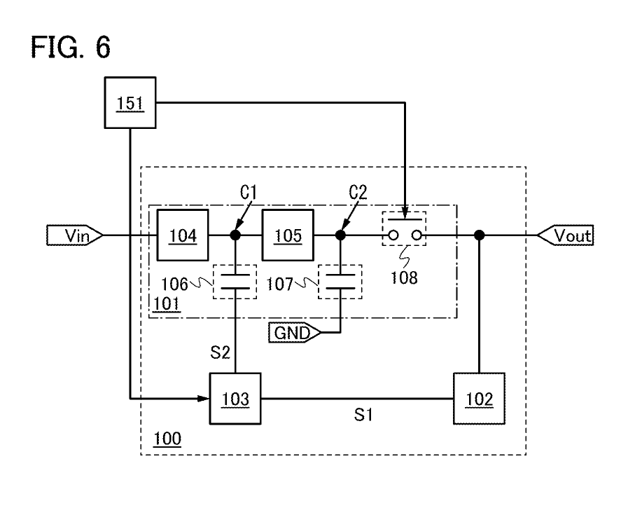

As a circuit which controls stopping or restarting of the supply of power supply voltage to the charge pump circuit 100 in FIG. 1 and controls on or off of the switch 108, a power supply control circuit may be provided outside the charge pump circuit 100. As an example, as shown in FIG. 6, on or off of the switch 108 and stopping or restarting of the supply of power supply voltage to the control circuit 103 included in the charge pump circuit 100 may be controlled by a power supply control circuit 151 which can be provided outside the charge pump circuit 100.

The timing chart in FIG. 5 shows a voltage level V_line representing whether or not power supply voltage is supplied, an SW representing on or off of the switch 108, the signal S1, the signal S2, and V_C1 and V_C2 representing voltage levels of the node C1 and the node C2, respectively.

The voltage level V_line shown in FIG. 5 represents whether or not power supply voltage is supplied. For example, power supply voltage is supplied to the charge pump circuit 100 in a period where the voltage level V_line is at a voltage level of a high power supply potential VDD, and the supply of power supply voltage to the charge pump circuit 100 is stopped in a period where the voltage level V_line is at a voltage level of a low power supply potential V_GND. Note that in FIG. 5, a period during which the supply of power supply voltage is performed is represented by P_on, and a period during which the supply of power supply voltage is stopped is represented by P_off.

As for the SW representing on or off of the switch 108 in FIG. 5, “ON” represents the state where the switch 108 is on, and “OFF” represents the state where the switch 108 is off. As shown in FIG. 5, the on or off of the switch 108 is performed at the same timing as the switching of the supply of power supply voltage.

The signal S1 shown in FIG. 5 is controlled so as to alternate increase and decrease in the voltage level between the voltage level VrefH and the voltage level VrefL which are output from the reference voltage generation circuit 203 included in the control circuit 103 in the period where the supply of power supply voltage is performed. Further, the voltage level of the signal S1 shown in FIG. 5 is decreased to the low power supply potential V_GND of the voltage level V_line in the period where the supply of power supply voltage is stopped.

In the timing chart shown in FIG. 5, the voltage level of the signal S1 is decreased to the low power supply potential V_GND when the switch 108 is switched off. In the timing chart shown in FIG. 5, the voltage level of the signal S1 can rise steeply in accordance with the electric charge held in the node C1 and the node C2 when the switch 108 is switched on.

The signal S2 shown in FIG. 5 intermittently toggles a voltage level between a voltage level CLK_H and a voltage level CLK_L. Note that the voltage level CLK_H may have the same potential as the high power supply potential VDD. Further, the voltage level CLK_L may have the same potential as the low power supply potential V_GND.

Further, the V_C1 shown in FIG. 5 is a voltage level in which increase and decrease in the voltage level is alternated on the basis of the Vin, between the low power supply potential V_GND and a voltage level (Vin+CLK_H) that is increased by a voltage level of the clock signal, CLK_H, from the voltage level of the input signal Vin.

Further, the V_C1 shown in FIG. 5 is the one that is changed from the input signal Vin in accordance with change in the voltage level of the signal S2. Specifically, the voltage level of the V_C1 changes in accordance with rising and falling of a waveform representing the voltage level of the signal S2.

The V_C2 shown in FIG. 5 is a voltage level controlled to alternate increase and decrease in the voltage level between the voltage level Vout_min and the Vout_max when the change in the voltage level of the output signal Vout is from Vout_min to Vout_max in a period where the supply of power supply voltage is performed. Further, the V_C2 shown in FIG. 5 is controlled so as to hold a voltage level when the supply of power supply voltage is stopped in a period where the supply of power supply voltage is stopped. Furthermore, when the supply of power supply voltage is restarted, electric charge held in the node C2 is discharged to the node to which an output signal is output; thus, the potential is decreased.

In the timing chart shown in FIG. 5, the voltage level of the node C2 when the switch 108 is switched off is held. The holding of the voltage level in the node C2 can be realized in such a manner that the switch 108 is turned off so that discharge of electric charge from the node C2 is reduced as much as possible. The discharge of the electric charge from the node C2 can be reduced as much as possible even if a transistor whose off state current per channel width is lower than or equal to 1×10⁻²² A/μm is used as the switch 108.

The operation of the timing chart shown in FIG. 5 is described.

In the P_on during which the supply of power supply voltage is performed, the voltage level of the signal S1 is decreased by leakage current in the detection circuit 102 and the like. When the voltage level of the signal S1 is lower than or equal to the voltage level VrefL, the signal S2 output from the control circuit 103 is switched to a clock signal from a signal with a constant voltage. The voltage level of the node C1 V_C1 is increased or decreased in accordance with toggle operation of the clock signal. In accordance with the transfer of electric charge to the node C2 at the time when the voltage level V_C1 is increased, the voltage level of the node C2 V_S2 is increased. The switch 108 is normally-on in the P_on; thus, the voltage level of the signal S1 is increased in accordance with the increase in the voltage level of the node C2 V_C2. When the voltage level of the signal S1 is higher than or equal to VrefH, the signal S2 output from the control circuit 103 is switched from the clock signal to a signal with a constant voltage.

In the P_off during which the supply of power supply voltage is stopped, the voltage level of the signal Si is decreased to the low power supply potential V_GND by turning off the switch 108. Further, since the supply of power supply voltage is stopped, the signal S2 has the voltage level CLK_L; that is, a potential equal to the low power supply potential V_GND that is a voltage level of the ground line GND. The discharge of electric charge from the node C1 with the voltage level V_C1 and the node C2 with the voltage level V_C2 can be reduced as much as possible by switching the switch 108 off, whereby the voltage level can be held. That is, in the example of the timing chart in FIG. 5, the voltage level of the input signal Vin can be held in the node C1, and the voltage level at the time when supply of power supply voltage is performed can be held in the node C2.

The voltage level of the signal S1 at the time when switching is performed from the P_off to the P_on where supply of power supply voltage is restarted can rise steeply in accordance with the electric charge held in the node C1 and the node C2 by switching the switch on. In accordance with the rise of this voltage level and the toggle operation of the clock signal of the signal S2 output from the control circuit 103, the voltage level of the node C2 is increased. A period during which the increase in the voltage level of the node C2 reaches the Vout_max from the start of the supply of the power supply voltage, is a period T_ret1 in an example shown in FIG. 5. In the timing chart shown in FIG. 5, the period T_ret1 specifically corresponds to three rises of the clock signal.

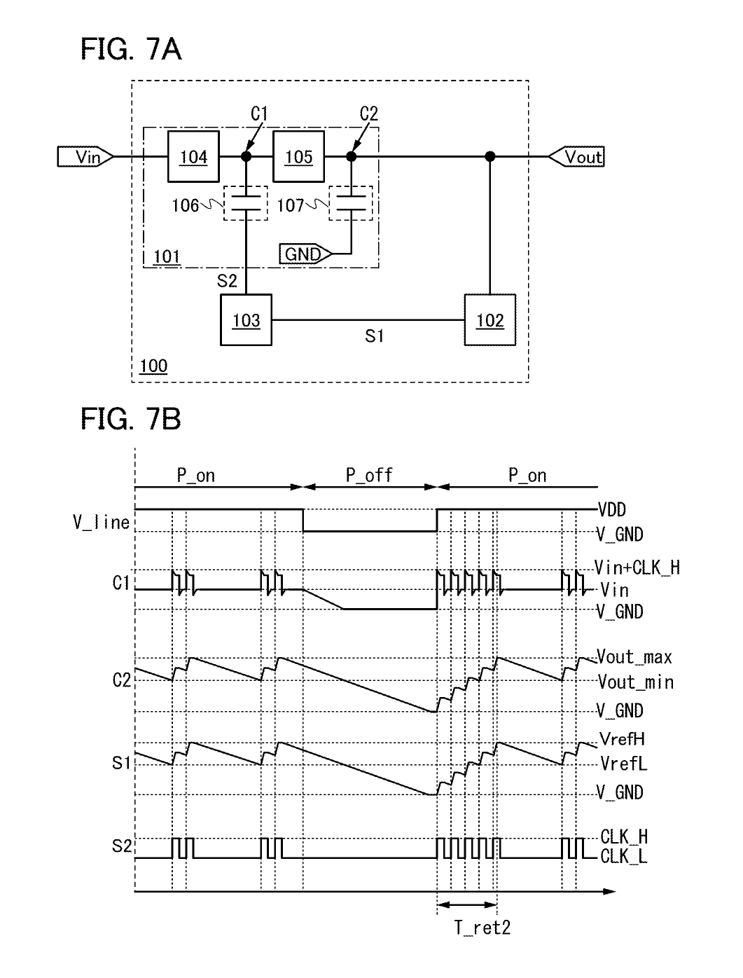

Here, for comparison with a structure of the charge pump circuit 100 shown in FIG. 1, a circuit diagram in which the switch 108 is excluded from the charge pump circuit 100 in FIG. 1 is shown in FIG. 7A and a timing chart thereof is shown in FIG. 7B. In the circuit diagram and the timing chart which are shown in FIGS. 7A and 7B, the description above can be referred to for the part that is the same as or similar to that in FIG. 1 and FIG. 5.

The circuit diagram and the operation of the timing chart which are shown in FIGS. 7A and 7B are described.

In the P_on during which supply of power supply voltage is performed, the voltage level of the signal S1 is decreased by leakage current in the detection circuit 102 and the like. When the voltage level of the signal S1 is lower than or equal to the voltage level VrefL, the signal S2 output from the control circuit 103 is switched from a signal with a constant voltage to a clock signal. In accordance with the toggle operation of the clock signal, the voltage level V_C1 of the node C1 is increased or decreased. The voltage level of the node C2 is increased by the transfer of electric charge to the node C2 when the voltage level V_C1 is increased. In the P_on, the voltage level of the signal S1 is increased by the increase of the voltage level of the node C2. When the voltage level of the signal S1 is higher than or equal to the voltage level VrefH, the signal S2 output from the control circuit 103 is switched from the clock signal to a signal with a constant voltage.

In the P_off during which the supply of power supply voltage is stopped, the voltage level of the signal S1 is decreased to the low power supply potential V_GND. Although the voltage level of the signal S1 becomes lower than or equal to the voltage level VrefL, the supply of the power supply voltage is stopped, and the voltage level of the signal S2 becomes the low power supply potential V_GND that is a voltage level of the ground line GND. Further, the voltage level V_C1 of the node C1 is decreased by discharge of electric charge from the capacitor through the charge transfer element 105, and finally becomes the low power supply potential V_GND that is a voltage level of the ground line GND, and the voltage level V_C2 of the node C2 also becomes the low power supply potential V_GND that is a voltage level of the ground line GND.

The voltage level of the signal S1 at the time when switching is performed from the P_off to the P_on where supply of power supply voltage is restarted is the low power supply potential V_GND that is a voltage level of the ground line GND. Thus, in accordance with the toggle operation of the clock signal of the signal S2 output from the control circuit 103, the voltage level of the node C2 is increased. However, the period during which the increase in the voltage level of the node C2 reaches the Vout_max from the start of the supply of the power supply voltage is a period T_ret2 in an example shown in FIG. 7. In the timing chart shown in FIG. 7B, the period T_ret2 specifically corresponds to five rises of the clock signal. That is, in the case where the switch 108 is not controlled, time required after the supply of power supply voltage is restarted and before the input signal is boosted becomes long.

As is clear from comparison between the period T_ret1 in the timing chart in FIG. 5 and the period T_ret2 in the timing chart in FIG. 7, by application of the circuit configuration of the charge pump circuit 100 of this embodiment in FIG. 1 to a structure in which the supply of power supply voltage is stopped and then is restarted, time required after the supply of power supply voltage is restarted and before the input signal is boosted can be shortened.

The above is the description of the operation of the charge pump circuit 100 in FIG. 1 in the normal condition and the operation thereof at the time when the supply of power supply voltage is stopped and restarted.

As described above, in the configuration of the charge pump circuit in this embodiment, when the supply of power supply voltage is stopped and restarted, discharge of electric charge from the capacitor can be reduced and time required after the supply of power supply voltage is restarted and before the input signal is boosted can be shortened.

This embodiment can be implemented combining with another embodiment as appropriate.

### Embodiment 2

In this embodiment, a modified example of the charge pump circuit 100 shown in FIG. 2 and described above in Embodiment 1 is described.

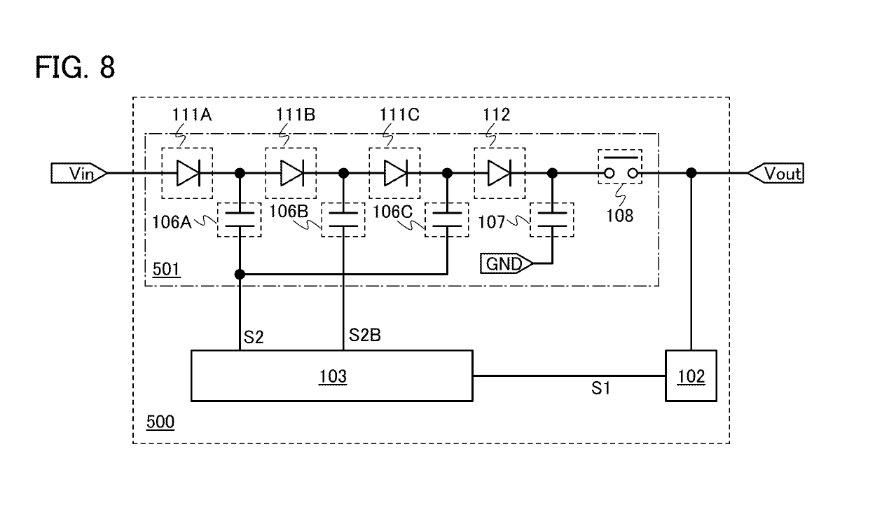

The charge pump circuit 500 shown in FIG. 8 includes a boosting circuit portion 501, the detection circuit 102, and the control circuit 103.

The boosting circuit portion 501 has a structure in which the diode element 111 and the capacitor 106 which are shown in FIG. 2 and described in Embodiment 1 are replaced with a diode element 111A, a diode element 111B and a diode element 111C, and a capacitor 106A, a capacitor 106B and a capacitor 106C which are formed in multiple stages. In that case, for example, the signal S2 is output from the control circuit 103 to the other electrodes of the capacitors 106A and 106C in the odd stages, and a signal S2B that is an inverted signal of the signal S2 is output from the control circuit 103 to the other electrode of the capacitor 106B in the even stage.

In the boosting circuit portion 501, the diode element 111A, the diode element 111B, the diode element 111C, the capacitor 106A, the capacitor 106B, and the capacitor 106C are provided to have arrangement as shown in FIG. 8, so that a charge pump circuit which can further boost the input signal Vin and output the boosted voltage as the output signal Vout can be obtained. As for the charge pump circuit shown in FIG. 8, when the supply of power supply voltage to the charge pump circuit is stopped and restarted, discharge of electric charge from the capacitors can be reduced and time required after the supply of power supply voltage is restarted and before the input signal is boosted can be shortened.

This embodiment can be implemented by being combined as appropriate with any of the above-described embodiments.

### Embodiment 3

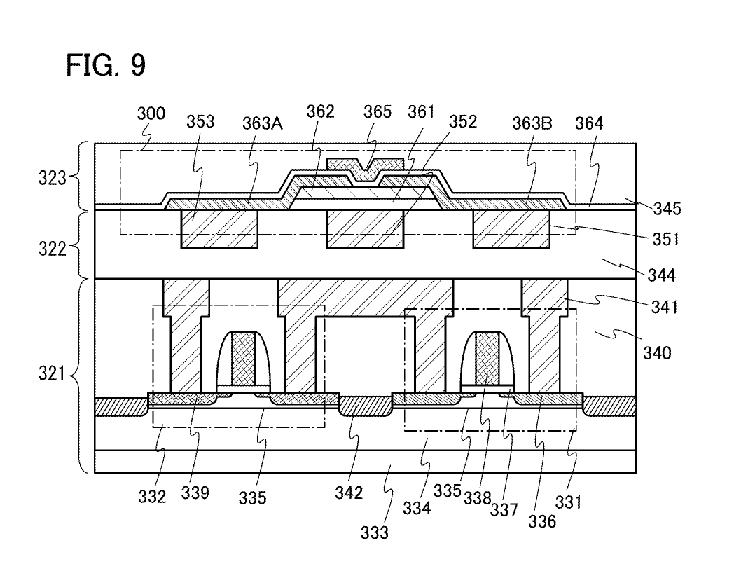

In this embodiment, a structure of a cross-sectional view of a semiconductor device is described with reference to FIG. 9. In the semiconductor device, a transistor which functions as a switch and whose channel is formed in an oxide semiconductor layer, which is described in Embodiment 1, and a transistor whose channel is formed in silicon included in a control circuit are stacked.

In the structure of the cross-sectional view of the semiconductor device shown in FIG. 9, an n-channel transistor 331 and a p-channel transistor 332 are shown as an example of transistors included in a control circuit forming a lower layer portion, and a transistor 300 whose channel is formed in an oxide semiconductor layer is shown as an example of a transistor forming an upper layer portion.

The semiconductor device shown in FIG. 9 includes a lower element layer 321 including the n-channel transistor 331 and the p-channel transistor 332 whose channel regions are formed using a silicon material, and an upper element layer 323 including the transistor 300 with a wiring layer 322 provided therebetween.

The n-channel transistor 331 in FIG. 9 includes an SOI layer 335 provided over a substrate 333 including a semiconductor material (e.g., silicon) with a BOX layer 334 provided therebetween, n-type impurity regions 336 formed in the SOI layer 335, a gate insulating layer 337, and a gate electrode 338. Although not illustrated, the SOI layer 335 includes intermetallic compound regions and a channel formation region in addition to the n-type impurity regions 336. In the p-channel transistor 332, p-type impurity regions 339 are formed in the SOI layer 335.

An element isolation insulating layer 342 is provided between the SOI layers 335 of the n-channel transistor 331 and the p-channel transistor 332, and an insulating layer 340 is provided to cover the n-channel transistor 331 and the p-channel transistor 332. Note that in the n-channel transistor 331 and the p-channel transistor 332, with the use of sidewalls formed on side surfaces of the gate electrodes 338 as shown in FIG. 9, regions having different concentrations of impurities may be included in the n-type impurity regions 336 and the p-type impurity regions 339.

The insulating layer 340 over the n-type impurity regions 336 and the p-type impurity regions 339 has openings, and wirings 341 are provided to fill the openings. In the wiring layer 322 over the insulating layer 340 and the wirings 341, an insulating layer 344, a wiring 351, a wiring 352, and a wiring 353 are provided. The wiring 351 can function as a source wiring of the transistor 300. The wiring 352 can function as a gate electrode of the transistor 300. The wiring 353 can function as a drain wiring of the transistor 300.

Note that the wirings 341 in the insulating layer 340 of the lower element layer 321, the wiring 351, the wiring 352, and the wiring 353 in the insulating layer 344 of the wiring layer 322 may be formed by a dual damascene method. Further, a contact plug may be formed to connect different wiring layers.

The n-channel transistor 331 and the p-channel transistor 332 each of which includes the SOI layer 335 including a semiconductor material can be operated at high speed and can be reduced in size as compared to the transistor 300.

After a top surface of the wiring layer 322 is subjected to chemical mechanical polishing (CMP) treatment, the transistor 300 may be formed.

The transistor 300 includes a gate insulating layer 361 and an oxide semiconductor film 362 which are stacked and formed in an island shape over the insulating film 344 and the wiring 352. Further, the transistor 300 includes a source electrode 363A which is formed over the gate insulating layer 361 and the oxide semiconductor film 362 which are formed in an island shape and is connected to the wiring 353, and a drain electrode 363B which is formed over the gate insulating layer 361 and the oxide semiconductor film 362 which are formed in an island shape and is connected to the wiring 351. Further, the transistor 300 includes an insulating layer 364 over the gate insulating layer 361 and the oxide semiconductor film 362 which are formed in an island shape, the insulating layer 344, and the source electrode 363A and the drain electrode 363B. Furthermore, the transistor 300 includes a back gate electrode 365 over the gate insulating layer 361 and the oxide semiconductor film 362 which are formed in an island shape, with the insulating layer 364 provided therebetween. The transistor 300 is covered with an insulating layer 345.

The transistor 300 including the back gate electrode 365 can have a structure in which a back gate voltage for controlling the threshold voltage is input to the back gate electrode 365. With the structure in which the back gate voltage is controlled so as to control the threshold voltage of the transistor 300, off-state current of the transistor 300 can be surely reduced.

As described above, in the structure of the semiconductor device in this embodiment, the transistors whose channel regions are formed using silicon and the transistor whose channel region is formed using the oxide semiconductor film can be provided by being stacked. As a result, a space for each element can be saved and thus the size of the semiconductor device can be reduced.

This embodiment can be implemented by being combined as appropriate with any of the above-described embodiments.

This application is based on Japanese Patent Application serial no. 2012-114473 filed with Japan Patent Office on May 18, 2012, the entire contents of which are hereby incorporated by reference.

What is claimed is:

1. A semiconductor device comprising:
a boosting circuit portion including a charge transfer element and a capacitor, the boosting circuit portion configured to boost a voltage level of an input signal, and configured to output an output signal having a boosted voltage level;
a detection circuit configured to monitor a voltage level of the output signal; and
a control circuit configured to output a signal for controlling boosting of the voltage level to the boosting circuit portion in accordance with the voltage level obtained by the detection circuit,
wherein the boosting circuit portion includes a switch electrically connected to the capacitor and the charge transfer element.

2. The semiconductor device according to claim 1, wherein the charge transfer element is a diode element.

3. The semiconductor device according to claim 1, wherein the detection circuit comprises two resistors.

4. The semiconductor device according to claim 1, wherein the control circuit comprises an operation amplifier.

5. The semiconductor device according to claim 1, wherein the control circuit comprises a reference voltage generation circuit.

6. The semiconductor device according to claim 1, wherein the control circuit comprises a flip-flop circuit.

7. The semiconductor device according to claim 1, wherein the control circuit comprises a selector circuit.

8. The semiconductor device according to claim 1, wherein the control circuit comprises an oscillator circuit.

9. A method for driving the semiconductor device according to claim 1, comprising the steps of:
turning off the switch in a period in which supply of power supply voltage is stopped; and
turning on the switch in a period in which supply of power supply voltage is performed.

10. A semiconductor device comprising:
a boosting circuit portion including a charge transfer element and a capacitor, the boosting circuit portion configured to boost a voltage level of an input signal, and configured to output an output signal having a boosted voltage level;
a detection circuit configured to monitor a voltage level of the output signal; and
a control circuit configured to output a signal for controlling boosting of the voltage level to the boosting circuit portion in accordance with the voltage level obtained by the detection circuit,
wherein the boosting circuit portion includes a transistor electrically connected to the capacitor and the charge transfer element, and
wherein a semiconductor layer of the transistor is an oxide semiconductor.

11. The semiconductor device according to claim 10, wherein the charge transfer element is a diode element.

12. The semiconductor device according to claim 10, wherein the detection circuit comprises two resistors.

13. The semiconductor device according to claim 10, wherein the control circuit comprises an operation amplifier.

14. The semiconductor device according to claim 10, wherein the control circuit comprises a reference voltage generation circuit.

15. The semiconductor device according to claim 10, wherein the control circuit comprises a flip-flop circuit.

16. The semiconductor device according to claim 10, wherein the control circuit comprises a selector circuit.

17. The semiconductor device according to claim 10, wherein the control circuit comprises an oscillator circuit.

18. A method for driving the semiconductor device according to claim 10, comprising the steps of:
turning off the transistor in a period in which supply of power supply voltage is stopped; and
turning on the transistor in a period in which supply of power supply voltage is performed.
